(19) United States
(12) Patent Application Publication
(10) Pub. No.: US 2005/0152554 A1
(43) Pub. Date: Jul. 14, 2005

(54) Method and apparatus for processing audio signals

(76) Inventor: Gin-Der Wu, Taipei (TW)

Correspondence Address: BIRCH STEWART KOLASCH & BIRCH, PO BOX 747, FALLS CHURCH, VA, 22040-0747, US

(21) Appl. No.: 10/806,108

(22) Filed: Mar. 23, 2004

(30) Foreign Application Priority Data
Jan. 9, 2004 (TW) 93100604

(51) Int. Cl. H04R 5/00

(52) U.S. Cl. 381/1; 381/17

(57) ABSTRACT

The present invention is related to a method and an apparatus for processing audio signals, which uses two speakers to simulate audio sounds with wide and 3D effects. The method provides a structure for processing audio signals by a plurality of analog elements (filter, gain amplifier, delay processing unit). The present invention also improves the bass part and strengthens 3D effects of the audio sounds. Therefore, the audio sounds output from the audio devices are more natural and smooth.

### BACKGROUND OF THE INVENTION

1. Field of the Invention

The present invention is a method and an apparatus for processing audio signals, especially relates to a method and an apparatus which comprises a plurality of amplifiers, filters and subtracters. It may also produce audio sound with wide and 3D effects.

2. Descriptions of Related Arts

With the progress of technology, requirements for family audio devices are more and more in recent years. Bass in audio sounds is enhanced and 3D effects are also simulated for high quality audio output devices. Prior art audio output devices includes a delay unit, a gain control unit, and other related audio processing units. A complicated audio device needs a powerful central processing unit, a digital signal processor and a memory with high capacity. It costs too much and is not practical for family application. Therefore, the present invention provides a simpler and effective algorithm structure to solve the above-mention problem.

### SUMMARY OF THE INVENTION

The present invention provides a method and an apparatus for processing audio signals. It uses two speakers to simulate 3D and wide effects for audio sounds. An algorithm structure in the present invention includes a plurality of gain amplifiers, substracters, delay processing unit, high-pass filters and low-pass filters. The high-pass filter is used to eliminate direct current (DC) gain, but it may also be saturated by audio signals. To prevent the high-pass filter from being saturated, a gain unit can be cascaded in front of the high-pass filter. A plurality of delay processing units and low-pass filters may compose a structure to produce audio signals with wide and 3D effects.

The various objects and advantages of the present invention will be more readily understood from the following detailed description when read in conjunction with the appended drawing, in which:

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, in which:

FIG. 1 shows a block diagram of a first embodiment of the present invention; FIG. 2 shows a block diagram of a second embodiment of the present invention; and FIG. 3 shows a block diagram of a third embodiment of the present invention.

### DETAILED DESCRIPTION OF PREFERRED EMBODIMENTS

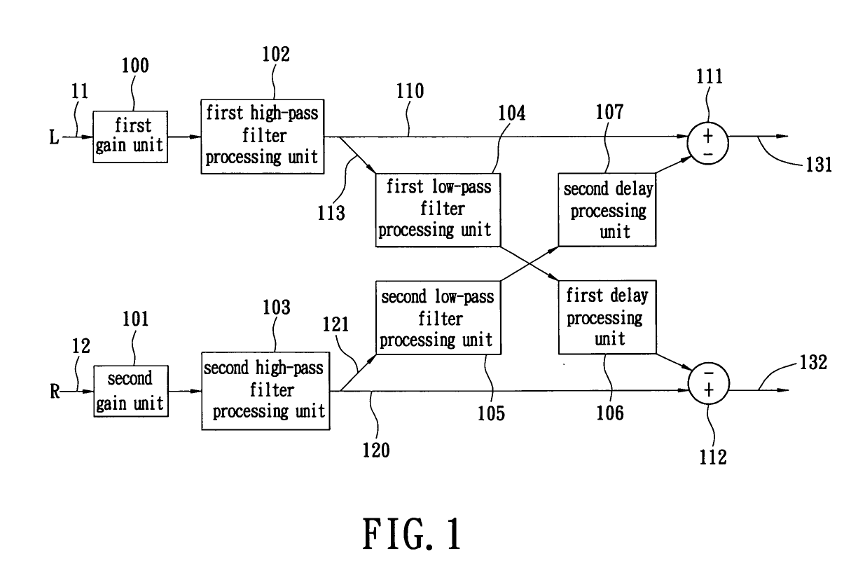

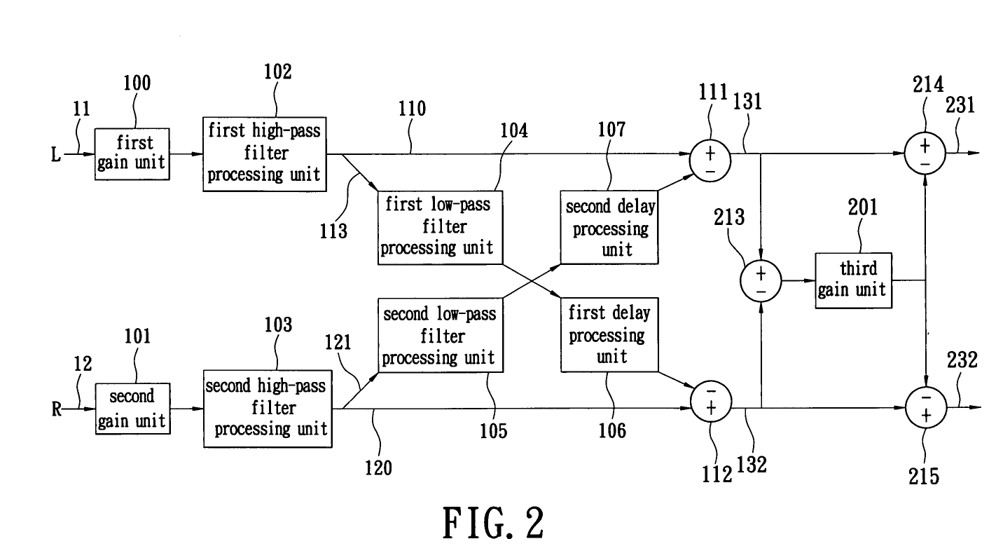

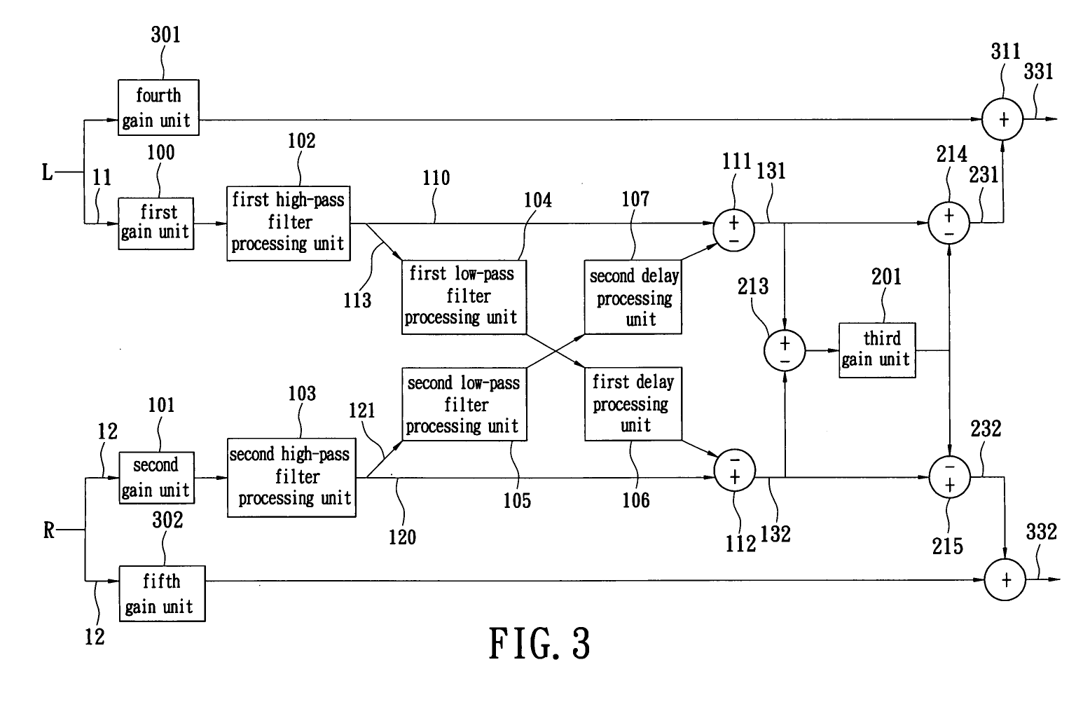

FIG. 1 shows a block diagram of an apparatus for processing audio signal according to the first embodiment of the present invention, and the apparatus for processing audio signal comprises a first gain unit 100, a first high-pass filter processing unit 102, a first low-pass filter processing unit 104, a first delay processing unit 106, a second gain unit 101, a second high-pass filter processing unit 103, a second low-pass filter processing unit 105, a second delay processing unit 107, a first subtracter 111, and a second subtracter 112.

The first low-pass filter processing unit 104 is connected to the first high-pass filter processing unit 102. The second low-pass filter processing unit 105 is connected to the a second high-pass filter processing unit 103. The first subtracter 111 is connected to the first high-pass filter processing unit 102 and the second delay processing unit 107. The second subtracter 112 is connected to the second high-pass filter processing unit 103 and the first delay processing unit 106.

Audio signals inputted to the structure may be divided into a left and a right channel input signals. After the left channel input signal 11 is processed by the first gain unit 100 and the first high-pass filter processing unit 102, it will be divided again into a first left channel input signal 110 and a second left channel input signal 113; and after a right channel input signal 12 is processed by the second gain unit 101 and the second high-pass filter processing unit 103, it will be divided again into a first right channel input signal 120 and a second right channel input signal 121. The first gain unit 100 and the second gain unit 101 can prevent the high-pass filter processing unit from being saturated. The first high-pass filter processing unit 102 and the second high-pass filter processing unit 103 also have an advantage of eliminating the direct current gain.

Next, the second left channel input signal 113 is processed by the low-pass filter processing unit and the delaying processing unit, and the processed signal will be subtracted with the first right channel input signal 120 to produce a first right channel output signal 132. The second right channel input signal 113 is processed by the low-pass filter processing unit and the delaying processing unit. The processed signal will then be subtracted with the first left channel input signal 110 to produce a first left channel output signal 131. Finally, the first left channel output signal 131 and the first right channel output signal 132 compensate for each other. With the above-mentioned processing steps, output audio sounds will have wide effects.

FIG. 2 shows a second embodiment of the present invention, and the apparatus for processing audio signal comprises: a first gain unit 100, a first high-pass filter processing unit 102, a first low-pass filter processing unit 104, a first delay processing unit 106, a second gain unit 101, a second high-pass filter processing unit 103, a second low-pass filter processing unit 105, a second delay processing unit 107, a first subtracter 111, a second subtracter 112, a third subtracter 213, a fourth subtracter 214, a fifth subtracter 215, and a third gain unit 201.

The first low-pass filter processing unit 104 is connected to the first high-pass filter processing unit 102. The second low-pass filter processing unit 105 is connected to the a second high-pass filter processing unit 103. The first subtracter 111 is connected to the first high-pass filter processing unit 102 and the second delay processing unit 107. The second subtracter 112 is connected to the second high-pass filter processing unit 103 and the first delay processing unit 106. The third subtracter 213 is connected to the first subtracter 111 and the second subtracter 112. The fourth subtracter 214 is connected to the first subtracter 111. The fifth subtracter 215 is connected to the second subtracter 112. The third gain unit 201 is connected to the third subtracter 213. The fourth subtracter 214 is connected to the fifth subtracter 215.

Audio signals inputted to the structure may be divided into left and right channel input signals. After the a left channel input signal 11 is processed by the first gain unit 100 and the first high-pass filter processing unit 102, it will be divided again into a first left channel input signal 110 and a second left channel input signal 113; and after a right channel input signal 12 is processed by the second gain unit 101 and the second high-pass filter processing unit 103, it will be divided again into a first right channel input signal 120 and a second right channel input signal 121. The first gain unit 100 and the second gain unit 101 can prevent the high-pass filter processing unit from being saturated. The first high-pass filter processing unit 102 and the second high-pass filter processing unit 103 also have a advantage of eliminating the direct current gain.

Next, the second left channel input signal 113 is processed by the low-pass filter processing unit and the delaying processing unit, and the processed signal will be subtracted with the first right channel input signal 120 to produce a first right channel output signal 132; the second right channel input signal 113 is processed by the low-pass filter processing unit and the delaying processing unit, and then the processed signal will be subtracted with the first left channel input signal 110 to produce a first left channel output signal 131. Finally, the first left channel output signal 131 and the first right channel output signal 132 compensate for each other. After the above-mentioned processing steps, output audio sounds will have wide effects. For obtaining better audio sounds, a gain processing sector is added behind the structure of the first embodiment, and comprises the third gain unit 201, the third subtracter 213, the fourth subtracter 214, the fifth subtracter 215. Parts of the first left channel output signal 131 will be processed by the third gain unit 201 and subtracted from the first right channel output signal 132 to produce a second left channel output signal 231; parts of the first right channel output signal 132 will be processed by the third gain unit 201 and subtracted from the first left channel output signal 131 to produce a second right channel output signal 232. Therefore, 3D effects are strengthened in the output audio signals as well as wide effects.

FIG. 3 shows a third embodiment of the present invention. The apparatus for processing audio signal comprises a first gain unit 100, a first high-pass filter processing unit 102, a first low-pass filter processing unit 104, a first delay processing unit 106, a second gain unit 101, a second high-pass filter processing unit 103, a second low-pass filter processing unit 105, a second delay processing unit 107, a first subtracter 111, a second subtracter 112, a third subtracter 213, a fourth subtracter 214, a fifth subtracter 215, a third gain unit 201, a fourth gain unit 301, a fifth gain unit 302, a first adder 311 and a second adder 312.

The first low-pass filter processing unit 104 is connected to the first high-pass filter processing unit 102. The second low-pass filter processing unit 105 is connected to the a second high-pass filter processing unit 103. The first subtracter 111 is connected to the first high-pass filter processing unit 102 and the second delay processing unit 107. The second subtracter 112 is connected to the second high-pass filter processing unit 103 and the first delay processing unit 106. The third subtracter 213 is connected to the first subtracter 111 and the second subtracter 112. The fourth subtracter 214 is connected to the first subtracter 111. The fifth subtracter 215 is connected to the second subtracter 112. The third gain unit 201 is connected to the third subtracter 213. The fourth subtracter 214 is connected to the fifth subtracter 215. The fourth subtracter 214 is connected to the first subtracter 311. The fifth subtracter 215 is connected to the second adder 312. The fourth gain unit 301 is connected between a left channel input port (not labeled) and the first adder 311. The fifth gain unit 302 is connected between a right channel input port (not labeled) and the second adder 312.

Audio signals inputted to the structure may be divided into left and right channel input signals. After the a left channel input signal 11 is processed by the first gain unit 100 and the first high-pass filter processing unit 102, it will be divided again into a first left channel input signal 110 and a second left channel input signal 113; and after a right channel input signal 12 is processed by the second gain unit 101 and the second high-pass filter processing unit 103, it will be divided again into a first right channel input signal 120 and a second right channel input signal 121. The first gain unit 100 and the second gain unit 101 can prevent the high-pass filter processing unit from being saturated. The first high-pass filter processing unit 102 and the second high-pass filter processing unit 103 also have a advantage of eliminating the direct current gain.

Next, the second left channel input signal 113 is processed by the low-pass filter processing unit and the delaying processing unit, and the processed signal will be subtracted with the first right channel input signal 120 to produce a first right channel output signal 132; the second right channel input signal 113 is processed by the low-pass filter processing unit and the delaying processing unit, and then the processed signal will be subtracted with the first left channel input signal 110 to produce a first left channel output signal 131. Finally, the first left channel output signal 131 and the first right channel output signal 132 will be compensated for each other. With the above-mentioned processing steps, output audio sounds will have wide effects. For obtaining better audio sounds, a gain processing sector is added behind the structure of the first embodiment, and which comprises the third gain unit 201, the third subtracter 213, the fourth subtracter 214, and the fifth subtracter 215. Parts of the first left channel output signal 131 will be processed by the third gain unit 201 and subtracted from the first right channel output signal 132 to produce a second left channel output signal 231; parts of the first right channel output signal 132 will be processed by the third gain unit 201 and subtracted from the first left channel output signal 131 to produce a second left channel output signal 232. Therefore, 3D effects are strengthened in the output audio signals as well as wide effects

The fourth gain unit 301 and the fifth gain unit 302 are appended for strengthening the bass part in the audio sounds and connected to the left and right channel input port, respectively. The left channel input signal 11 is processed by the gain unit and added with the second left channel output signal 231 to produce a third left channel output signal 331; the left channel input signal 12 is processed by the gain unit and added with the second right channel output signal 232 to produce a third right channel output signal 332. Hence, the bass parts in the third left channel output signal 331 and the third right channel output signal 332 are more powerful. Alto and treble voice parts are most important in audio sounds. With the strengthening of bass part, the alto and treble voice parts will not be too shrill and piercing and the output sound is thus natural and smooth. The fourth gain unit 301 and the fifth gain unit 302 may prevent the alto and treble voice parts from decay and keep the output signals from being saturated.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. A method for processing audio signals, and processing left and right channel audio signals, comprising the steps of:
processing a left channel input signal by a gain unit and a high-pass filter; and then dividing the left channel input signal into a first left channel signal and a second left channel signal;
processing a right channel input signal by a gain unit and a high-pass filter, and then dividing the right channel input signal into a first right channel signal and a second right channel signal;
processing the second left channel signal by a low-pass filter processing unit and a delaying processing unit, and subtracting a processed signal from the first right channel input signal to produce a first right channel output signal; and
processing the second right channel signal by a low-pass filter processing unit and a delaying processing unit, and subtracting a processed signal from the first left channel input signal to produce a first left channel output signal.

2. The method for processing audio signals as in claim 1, further comprising:
processing parts of the first left channel output signal by a gain unit and subtracting the processed first left channel output signal from the first right channel output signal to produce a second left channel output signal; and
processing parts of the first right channel output signal by a gain unit and subtracting the processed first right channel output signal from the first left channel output signal to produce a second right channel output signal.

3. The method for processing audio signals as in claim 2, further comprising:
processing the left channel input signal by a gain unit and adding the processed left channel input signal to the second left channel output signal;
processing the right channel input signal by a gain unit and adding the processed right channel input signal to the second right channel output signal.

4. An apparatus for processing audio signals, and processing left and right channel audio signals, comprising:
a first gain and high-pass filter processing unit;
a first low-pass filter processing and delay processing unit connected with the first gain and high-pass filter processing unit;
a second gain and high-pass filter processing unit;
a second low-pass filter processing and delay processing unit connected with the second gain and high-pass filter processing unit;
a first subtracter connected to the output of the first gain and high-pass filter processing unit as well as the second low-pass filter processing and delay processing unit; and
a second subtracter connected to the output of the second gain and high-pass filter processing unit as well as the first low-pass filter processing and delay processing unit.

5. The apparatus for processing audio signals as in claim 4, further comprising:
a third subtracter connected to the first subtracter and the second subtracter;
a fourth subtracter connected to the first subtracter;
a fifth subtracter connected to the second subtracter; and
a third gain unit connected to the third subtracter, the fourth subtracter, and the fifth subtracter.

6. The apparatus for processing audio signals as in claim 4, further comprising:
a first amplifier connected to the left channel output port and the fourth subtracter; and
a second amplifier connected to the right channel output port and the fifth subtracter.
